(19) United States
(12) Patent Application Publication
(10) Pub. No.: US 2017/0010869 A1
(43) Pub. Date: Jan. 12, 2017

(54) MULTISTAGE CUSTOMIZING OF WEB-BASED APPLICATION IN A BROWSER INDEPENDENT OF PLATFORM AND OPERATING SYSTEM

(71) Applicant: AIRSPRING SOFTWARE, LLC, Lexington, KY (US)

(72) Inventors: Ron HEINEY, Harrodsburg, KY (US); Rob GUCKENBERGER, Lexington, KY (US); Jarrod ZYWIEN, Lexington, KY (US); Allen COOK, Lexington, KY (US)

(21) Appl. No.: 15/113,632

(22) PCT Filed: Jan. 22, 2014
(86) PCT No.: PCT/US2014/012499

§ 371 Date: Jul. 22, 2016

(51) Int. Cl. G06F 9/44; G06F 17/24; G06F 17/30

(52) U.S. Cl. CPC G06F 8/35; G06F 17/30893; G06F 17/248

(57) ABSTRACT

Methods, systems, and apparatuses, including computer programs encoded on computer storage medium, for customizing a web-based application in a browser by primary user for use by secondary user independent of either user's platform or operating system. A system customizes a web-based application by retrieving an application template defined in markup language supported by the browser and having a plurality of elements, altering one of plurality of elements, storing a user data element indicative of the alteration to the element, and associating the user data element with the primary user. The user data element is published as a seed data element associated with the primary user. The secondary user can access the template and the seed data element associated with the primary user in a browser of the secondary user' s platform such that the template and the seed data element associated with the primary user together represent a customized web-based application.

### FIELD OF THE INVENTION

The present invention relates generally to customizing web-based applications in a browser independent of platform or operating system.

### BACKGROUND OF THE INVENTION

Businesses communicate with customers, employees, partners and others through various routine and ad hoc document based communications. A non-exhaustive list of examples of such communications includes monthly statements, bills, and invoices; semi-annual or annual documents such as policies or shareholder reports; and, business activity related communications such as letters, contracts, and proposals.

These document based communications typically require personalization through the inclusion of data, in varying forms, from or about the communication recipient. The inclusion of customer or user specific data, such as customer billing data, credit card transactions, or bank credits/debits, requires the communications to be dynamic in their layout to accommodate substantial variability. For example, one customer recipient may have a dozen credit card transactions whereas another may have hundreds. Even more, such data may need to be in tabular, graphical and/or chart formats for improved readability. In final form, each recipient's communication is personalized because the user specific data associated with their respective accounts, transactions, policies or the like are unique to them.

Other business activity related communications may require business users to edit partially composed communications in order to finalize them for recipient consumption. A system generated communication for an insurance claim status, for instance, may require an in-house claims representative to select or update certain user specific information based on input from an insurance agent or a police report. In some instances, business rules may dictate that only certain portions, sections, or text in a communication can be changed based on the editor's role in or relationship with the organization. Regardless of the type of data found in such communications, variable substitution in business communications is commonly required.

Such communications are often created as a template that consists of standard, approved language. As part of normal business operation, modifications are made to an instance of the template, in the form of a document, for appropriate customization or personalization. Current template implementations generally consist of word processing documents (e.g., Microsoft® Word documents) with macros or other instructions embedded therein to assist an end user in completing the document. Altering such documents may include changing the macros or other instructions, altering language within the document or changing the format of the document. Occasionally, the alterations, such as edits, deletions, additions and/or changes, need to be saved for future use. In these instances, the altered template content, macros or other instructions, embedded therein, and/or formatting, are stored as a new template version. This is traditionally accomplished by saving the template, inclusive of all changes, as a new, single record for future recall by users.

In other words, alterations made to templates based on word processing formats like Microsoft's is an “all or nothing” situation. A user has either read only or read/write access to the entire template. Therefore, if any alterations are made to the template, the business must consider the need for appropriate review and approval of such alterations, intended or inadvertent.

If approved, a new template is created and stored in its entirety. In other words, the layout and content, whether changed or unchanged from the prior version, are stored as a new template. Due to the frequency of changes which typically occur in such templates, this approach manifests itself in the form of a large, and ultimately unmanageable, population of templates.

As the volume of templates grows, so too do the inherent costs of managing the templates. As a result, alterations to common content, such as a company logo or address in letterhead, are difficult to manage due to the volume of templates requiring alteration. An administrator must know, or easily find, each of the templates that require alteration to include the new logo. Alternatively, different departments within a business or business partners may each require slight variations of a standard template. In this scenario, each department or business partner will require the creation of their own template including any subsequent versions of templates resulting from alterations to the original department or business partner template.

Even more, distribution of, or providing access to, new templates and retiring or deleting outdated templates are two common activities required by a business relying on such standardized templates. As new templates are created through alterations to original templates, the new templates must be made available to users. This may require system changes granting user access or possibly require the distribution of the new templates to all potential users. The distribution of such new templates, while required for business operations, often creates new issues when users struggle to determine the appropriate, or latest, version of template they should be using for the task at hand. Unless the original templates are immediately deleted, confusion can arise. Even more, users often desire to simply pull up old, already populated templates, for further editing but these existing templates are now out of date.

Despite the predominance of distributed, desktop software, business user's and application developer's preferences are moving toward using browser-based solutions to perform their job functions. In addition to eliminating the need for local software installation, browser-based solutions enable users to work from any location from a variety of devices. Corporate information technology departments prefer browser-based software as well due to the inherent costs associated with maintaining user desktop computers and required software.

In addition to browser-based solutions, business employees and customers alike are increasingly adopting and using their mobile devices, such as smartphones and tablets, to engage with each other and businesses. Therefore, businesses are beginning to create custom applications to interact with their employees and customers in this manner.

Web-based document template solutions help minimize the issues of distribution as the templates are retrieved from a centralized location each time the templates are accessed. Intelligent documents, with permissions by user group defined for example, protect against inadvertent changes and help to streamline the review process, if needed. Web-based applications, or communications or documents, that are defined with their changes maintained separately (and applied when needed) eliminate the confusion and necessity of ongoing management of increasing volumes of templates. Far fewer templates allow for more rapid changes for common content such as logo's and addresses, for instance, because the changes are made to a master template and the changes are inherited by all subsequent uses.

Accordingly, a method of customizing a web-based application or communication in a browser by a primary user for use by a secondary user independent of the primary and secondary user's platform or operation system is needed. Preferably, the method would provide for the retrieval and altering of a web-based application template or communication in a browser environment without desktop software, plug-ins or virtualized environment, and storing of the alterations associated with the primary user such that a secondary user can retrieve the web-based application template or communication and the stored alterations which together represent a customized web-based application or communication. All of these features are provided by the following invention.

### SUMMARY OF THE INVENTION

The present invention meets these needs by providing methods, systems, and apparatuses, including computer programs encoded on a computer storage medium, for customizing a web-based application or communication in a browser by a primary user for use by a secondary user independent of the primary and secondary user's platform or operating system.

In accordance with a first aspect of the invention, a computer-implemented method is disclosed. The method includes the steps of retrieving a web-based application template defined in markup language supported by the browser, said template including a plurality of elements, altering at least one of the plurality of elements, storing at least one user data element indicative of the alteration to the at least one of the elements, and associating the at least one user data element with the primary user. The step of altering at least one of the plurality of elements occurs through interaction by the primary user with the primary user's platform in addition to other methods including, for example, alterations based on location of the primary user's platform.

In accordance with a second aspect of the invention, the plurality of elements of the web-based application template may include content elements and data elements. Even more, the plurality of elements of the web-based application template include at least one canvas element, and the step of altering at least one of the plurality of elements includes altering at least one element within the at least one canvas element through the interaction by the primary user with the primary user's platform. The step of altering at least one of the plurality of elements may further include adding at least one new element within the at least one canvas element through interaction by the primary user with the primary user's platform.

In accordance with a third aspect of the invention, the web-based application template may be further customized before retrieval by secondary users. In this instance, the method further includes the steps of retrieving (1) the web-based application template including the plurality of elements and (2) the at least one user data element associated with the primary user, altering at least one of (1) the plurality of elements and (2) the at least one user data element associated with the primary user, storing at least one additional user data element indicative of the secondary alteration to the at least one of (1) the plurality of elements and (2) the at least one user data element associated with the primary user, and associating the at least one additional user data element with the primary user. The steps of retrieving, altering, storing, and associating may be repeated for subsequent alterations by the primary user allowing for multiple sessions.

Once the primary user has customized the web-based application template, whether in a single or multiple sessions, the customized web-based application template is made available for secondary users by publishing the at least one user data element and the at least one additional user data element as at least one seed data element associated with the primary user. In this manner, the secondary user can access the web-based application template and the at least one seed data element associated with the primary user in a browser of the secondary user's platform such that the web-based application template and the at least one seed data element associated with the primary user together represent a customized web-based application.

In accordance with a fourth aspect of the invention, each of the plurality of elements of the web-based application template is associated with at least one right. In this instance, the method further includes the step of authenticating a right of the primary user to retrieve each of the plurality of elements of the web-based application template. The method could further include the step of authenticating a right of the primary user to alter the at least one of the plurality of elements. This allows for some or all of the elements to be retrieved and/or altered by the primary user dependent upon rights assigned thereto. The rights could also require authentication of the right of the user to store the at least one primary user data element indicative of the alteration to the at least one of the plurality of elements.

Even more, the web-based application template itself may be associated with retrieval rights, and the step of authenticating a right of the primary user to retrieve the web-based application template would be required prior to authenticating any further rights described above.

As indicated above, once the primary user has customized the web-based application template, whether in a single or multiple sessions, the customized web-based application template is made available for secondary users by publishing the at least one user data element and the at least one additional user data element, if multiple sessions were required, as at least one seed data element associated with the primary user. In accordance with another aspect of the invention, at least one right for the at least one seed data element associated with the primary user is established. The established at least one right for the at least one seed data element associated with the primary user can determine whether the secondary user can (1) retrieve the at least one seed data element and (2) alter the at least one seed data element. Once established, the method further includes the step of authenticating a right of the secondary user to retrieve the at least one seed data element associated with the primary user. Each of the rights associated with the web-based application template and the primary user can be established and authenticated for secondary, tertiary, and subsequent users as well.

In accordance with yet another aspect of the invention, the secondary user can include a plurality of users (e.g., employees or enrollees) and each of the secondary users is able to retrieve the web-based application template and the at least one seed data element associated with the primary user. Whether the secondary user is a single user or a plurality of users, the secondary user(s) can retrieve the web-based application template as customized by the primary user. Even more, the secondary user(s) is able to alter at least one of (1) the plurality of elements and (2) the at least one seed data element associated with the primary user, and store at least one secondary user data element indicative of the alteration, and associate the at least one secondary user data element with the secondary user(s). As with the primary user, the step of altering at least one of the plurality of elements occurs through interaction by the secondary user(s) with the secondary user's platform in addition to other methods including, for example, alterations based on location of the secondary user's platform.

In the instance where more than one secondary user is customizing the web-based application template, the alterations are associated with the individual secondary user and stored as a customized web-based application template of the particular secondary user. Of course, each of these steps may be subject to the establishment and authentication of rights of the secondary user(s). These rights may vary from one secondary user to another secondary user within the plurality of secondary users (e.g., employee—management, employee—non-management).

Once one of the plurality of secondary users has customized the web-based application template, whether in a single or multiple sessions, the customized web-based application template is made available for tertiary or subsequent users by publishing the at least one secondary user data element as at least one secondary seed data element associated with the particular secondary user. In this manner, tertiary or subsequent users can access the web-based application template, the at least one seed data element associated with the primary user, and the at least one secondary seed data element associated with the particular secondary user in a browser of the tertiary or subsequent users' platform such that the web-based application template, the at least one seed data element associated with the primary user, and the at least one secondary seed data element associated with the particular secondary user together represent a customized web-based application.

As with the at least one seed data element associated with the primary user, at least one right for the at least one secondary seed data element may be established. The established at least one right for the at least one secondary seed data element associated with the secondary user can determine whether the tertiary or subsequent users can (1) retrieve the at least one secondary seed data element and (2) alter the at least one secondary seed data element. Once established, the method further includes the step of authenticating a right of the tertiary or subsequent users to retrieve the at least one secondary seed data element associated with the secondary user.

In accordance with a different aspect of the invention, another computer-implemented method is disclosed which includes the steps of retrieving (1) a web-based application template defined in markup language supported by the browser, said template including a plurality of elements, and (2) at least one prior seed data element indicative of an alteration to at least one of the plurality of elements made by a prior level user, altering at least one of (1) the plurality of elements and (2) the at least one prior seed data element, storing at least one current user data element indicative of the alteration to the at least one of (1) the plurality of elements and (2) the at least one prior seed data element, and associating the at least one current user data element with a current level user. The step of altering occurs through interaction by the current level user with the current level user's platform in addition to other methods including, for example, alterations based on location of the current level user's platform.

In accordance with another aspect of the invention, the plurality of elements of the web-based application template may include content elements and data elements. Even more, the plurality of elements may include at least one canvas element, and the step of altering at least one of (1) the plurality of elements and (2) the at least one prior seed data element includes altering at least one element within the at least one canvas element through the interaction by the current user with the current user's platform. The step of altering at least one of (1) the plurality of elements and (2) the at least one prior seed data element may further include adding at least one new element within the at least one canvas element through interaction by the current user with the current user's platform.

In accordance with still another aspect of the invention, the web-based application template may be further customized by the current level user before retrieval by subsequent level users. In this instance, the method further includes the steps of retrieving (1) the web-based application template including the plurality of elements, (2) the at least one prior seed data element associated with the prior level user, and (3) the at least one current level user data element, altering at least one of (1) the plurality of elements, (2) the at least one prior seed data element associated with the prior level user, and (3) the at least one current level user data element, storing at least one additional current user data element indicative of the secondary alteration to the at least one of (1) the plurality of elements, (2) the at least one prior seed data element associated with the prior level user, and (3) the at least one current level user data element, and associating the at least one additional current level user data element with the current level user. The steps of retrieving, altering, storing, and associating may be repeated for subsequent alterations by the current level user allowing for multiple sessions.

Once the current level user has customized the web-based application template, whether in a single or multiple sessions, the customized web-based application template is made available for subsequent level users by publishing the at least one current level user data element, and the at least one additional current level user data element if added in one or more multiple sessions, as at least one current seed data element associated with the current level user. In this manner, the subsequent level user can retrieve (1) the web-based application template, (2) the at least one prior seed data element, and (3) the at least one current seed data element associated with the current level user in a browser of the subsequent level user's platform such that the web-based application template, the at least one prior seed data element, and the at least one current seed data element associated with the current level user together represent a customized web-based application.

In accordance with another aspect of the invention, (1) the plurality of elements of said web-based application template and (2) the at least one prior seed data element indicative of the alteration to the at least one of the plurality of elements of the web-based application template are associated with at least one right. The method may further include the step of authenticating a right of the current level user to retrieve each of (1) the plurality of elements and (2) the at least one prior seed data element. The method could further include the step of authenticating a right of the current level user to alter each of (1) the plurality of elements and (2) the at least one prior seed data element. This allows for some or all of the web-based application template and the at least one prior seed data element to be retrieved and/or altered by the current level user dependent upon rights assigned thereto. The rights could also require authentication of the right of the current level user to store the at least one current level user data element indicative of the alteration to the at least one of (1) the plurality of elements and (2) the at least one prior seed data element.

Even more, the web-based application template itself may be associated with retrieval rights, and the step of authenticating a right of the current user to retrieve the web-based application template would be required prior to authenticating any further rights described above.

In accordance with another aspect of the invention, a computer storage medium encoded with a computer program is disclosed. The program includes instructions that when executed by one or more computers cause one or more computers to perform operations for customizing a web-based application in a browser by a primary user for use by a secondary user independent of the primary and secondary user's platform or operating system, including, retrieving a web-based application template defined in markup language supported by the browser, said template including a plurality of elements, altering at least one of the plurality of elements, storing at least one user data element indicative of the alteration to the at least one of the elements, and associating the at least one user data element with the primary user. The step of altering at least one of the plurality of elements occurs through interaction by the primary user with the primary user's platform in addition to other methods including, for example, alterations based on location of the primary user's platform.

Even more, the plurality of elements of the web-based application template include at least one canvas element, and the step of altering at least one of the plurality of elements includes altering at least one element within the at least one canvas element through the interaction by the primary user with the primary user's platform. The step of altering at least one of the plurality of elements may further include adding at least one new element within the at least one canvas element through interaction by the primary user with the primary user's platform.

As outlined above with regard to the method, the web-based application template may be further customized before retrieval by secondary users. In this instance, the method further includes the steps of retrieving (1) the web-based application template including the plurality of elements and (2) the at least one user data element associated with the primary user, altering at least one of (1) the plurality of elements and (2) the at least one user data element associated with the primary user, storing at least one additional user data element indicative of the secondary alteration to the at least one of (1) the plurality of elements and (2) the at least one user data element associated with the primary user, and associating the at least one additional user data element with the primary user. The steps of retrieving, altering, storing, and associating may be repeated for subsequent alterations by the primary user allowing for multiple sessions. Alternatively, the secondary user can include a plurality of users (e.g., employees or enrollees) and each of the secondary users is able to retrieve the web-based application template and the at least one seed data element associated with the primary user as described in more detail above with regard to the method.

The instructions of the computer program encoded on the computer storage medium, that when executed by one or more computers cause one or more computers to perform operations for customizing a web-based application in a browser by a primary user for use by a secondary user independent of the primary and secondary user's platform or operating system further include each of the aspects described above with regard to the method steps of customizing a web-based application in a browser by a primary user for use by a secondary user independent of the primary and secondary user's platform or operating system. More specifically, the aspects described in the above paragraphs numbered 0019-0026.

In accordance with yet still another aspect of the invention, a computer storage medium encoded with a computer program is disclosed. The program includes instructions that when executed by one or more computers cause one or more computers to perform operations for customizing a web-based application in a browser by multiple levels of users independent of the user's platform or operating system, including the steps of retrieving (1) a web-based application template defined in markup language supported by the browser, said template including a plurality of elements, and (2) at least one prior seed data element indicative of an alteration to at least one of the plurality of elements made by a prior level user, altering at least one of (1) the plurality of elements and (2) the at least one prior seed data element, storing at least one current user data element indicative of the alteration to the at least one of (1) the plurality of elements and (2) the at least one prior seed data element, and associating the at least one current user data element with a current level user. The step of altering occurs through interaction by the current level user with the current level user's platform in addition to other methods including, for example, alterations based on location of the current level user's platform.

The instructions of the computer program encoded on the computer storage medium, that when executed by one or more computers cause one or more computers to perform operations for customizing a web-based application in a browser by multiple levels of users independent of the user's platform or operating system further include each of the aspects described above with regard to the method steps of customizing a web-based application in a browser by multiple levels of users independent of the user's platform or operating system. More specifically, the aspects described in the above paragraphs numbered 0028-0032.

In accordance with another aspect of the invention, a system comprising one or more computers is disclosed. A computer-readable medium may be coupled to the one or more computers and have instructions stored thereon which, when executed by the one or more computers, cause the one or more computers to perform operations for customizing a web-based application in a browser by a primary user for use by a secondary user independent of the primary and secondary user's platform or operating system. The operations include retrieving a web-based application template defined in markup language supported by the browser, said template including a plurality of elements, altering at least one of the plurality of elements, storing at least one user data element indicative of the alteration to the at least one of the elements, and associating the at least one user data element with the primary user. The step of altering at least one of the plurality of elements occurs through interaction by the primary user with the primary user's platform in addition to other methods including, for example, alterations based on location of the primary user's platform.

Even more, the plurality of elements of the web-based application template include at least one canvas element, and the step of altering at least one of the plurality of elements includes altering at least one element within the at least one canvas element through the interaction by the primary user with the primary user's platform. The step of altering at least one of the plurality of elements may further include adding at least one new element within the at least one canvas element through interaction by the primary user with the primary user's platform.

As outlined above with regard to the method, the web-based application template may be further customized before retrieval by secondary users. In this instance, the method further includes the steps of retrieving (1) the web-based application template including the plurality of elements and (2) the at least one user data element associated with the primary user, altering at least one of (1) the plurality of elements and (2) the at least one user data element associated with the primary user, storing at least one additional user data element indicative of the secondary alteration to the at least one of (1) the plurality of elements and (2) the at least one user data element associated with the primary user, and associating the at least one additional user data element with the primary user. The steps of retrieving, altering, storing, and associating may be repeated for subsequent alterations by the primary user allowing for multiple sessions. Alternatively, the secondary user can include a plurality of users (e.g., employees or enrollees) and each of the secondary users is able to retrieve the web-based application template and the at least one seed data element associated with the primary user as described in more detail above with regard to the method.

The system comprising one or more computers including a computer-readable medium that is coupled to the one or more computers and has instructions stored thereon which, when executed by the one or more computers, cause the one or more computers to perform operations for customizing a web-based application in a browser by a primary user for use by a secondary user independent of the primary and secondary user's platform or operating system further includes each of the aspects described above with regard to the method steps of customizing a web-based application in a browser by a primary user for use by a secondary user independent of the primary and secondary user's platform or operating system. More specifically, the aspects described in the above paragraphs numbered 0019-0026.

In accordance with another aspect of the invention, a system comprising one or more computers is disclosed. A computer-readable medium may be coupled to the one or more computers and have instructions stored thereon which, when executed by the one or more computers, cause the one or more computers to perform operations for customizing a web-based application in a browser by multiple levels of users independent of the user's platform or operating system, including the steps of retrieving (1) a web-based application template defined in markup language supported by the browser, said template including a plurality of elements, and (2) at least one prior seed data element indicative of an alteration to at least one of the plurality of elements made by a prior level user, altering at least one of (1) the plurality of elements and (2) the at least one prior seed data element, storing at least one current user data element indicative of the alteration to the at least one of (1) the plurality of elements and (2) the at least one prior seed data element, and associating the at least one current user data element with a current level user. The step of altering occurs through interaction by the current level user with the current level user's platform in addition to other methods including, for example, alterations based on location of the current level user's platform.

The system comprising one or more computers including a computer-readable medium that is coupled to the one or more computers and has instructions stored thereon which, when executed by the one or more computers, cause the one or more computers to perform operations for customizing a web-based application in a browser by multiple levels of users independent of the user's platform or operating system further includes each of the aspects described above with regard to the method steps of customizing a web-based application in a browser by multiple levels of users independent of the user's platform or operating system. More specifically, the aspects described in the above paragraphs numbered 0028-0032.

The Summary and Abstract sections may set forth one or more but not all exemplary embodiments of the present invention as contemplated by the inventor(s), and thus, are not intended to limit the present invention and the appended claims in any way.

Other embodiments may include corresponding systems, apparatus, and computer programs, configured to perform the actions of the methods, encoded on computer storage devices. These and other embodiments of the invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification illustrate several aspects of the invention and, together with the description, assist in explaining the principles of the invention. In the drawings:

FIG. 1 is a block diagram of a representative client and server communication network over which the communication and data may be exchanged;

FIG. 2 illustrates an exemplary database;

FIG. 3 is a flow diagram of a method of creating a communication including user specific content editable in a browser by a user independent of the user's platform or operating system; and

FIG. 4 is a block diagram of a representative system that could be used to embody or implement embodiments, or portions thereof, of the present invention described herein.

Reference will now be made in detail to the present preferred embodiment of the invention, an example of which is illustrated in the accompanying drawings.

### DETAILED DESCRIPTION OF THE PREFERRED EMBODIMENT

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the invention, methods, systems, and apparatuses, including computer programs encoded on a computer storage medium, are hereinafter described for use in customizing a web-based application, or communication, in a browser by a primary user for use by a secondary user independent of the primary or secondary user's platform or operating system.

The phrase web-based application is generally broadly defined as any application that uses a web browser as a client. In other words, a web-based application is a computer software application, including mobile applications, that is coded in a browser-supported programming language, such as JavaScript®, combined with a browser-rendered markup language like hyper-text markup language, or HTML, and reliant on a common web browser to render the application executable. Web-based applications include any type of communication containing electronic media content.

With regard to the present invention, a web-based application is a communication, a computer file containing electronic media content such as a business document, a website, a webpage, or any other means of exchanging content. Such web-based applications are viewable by users of computers, such as laptops, desktops or tablet computers, or through mobile devices, smartphones, or other like platforms utilizing a browser. In accordance with the present invention, the web-based application may be edited in the browser of a platform without requiring the browser user to download or install additional code for capabilities that may not already be supported by the user's browser. This is the case regardless of the user's platform or operating system.

Generally speaking, a browser retrieves a communication or application from a server and displays the communication to a user. The communication is typically a computer file written or defined in a markup language, such as HTML, that may have text, graphic images, and even multimedia objects, such as audio or video recordings, among others that are associated with the file. As is well known by those skilled in the field, HTML is composed of HTML elements. Each element can have HTML attributes specified. Elements can also have content, including other elements and text, for example. HTML elements represent semantics, or meaning. For example, the “title” element represents the title of the communication.

A communication defined in markup language further includes control tags and data. The control tags identify the structure: for example, the headings, subheadings, paragraphs, lists, and embedding of images. The data consists of the content, such as text, images, multimedia, and the like, which are displayed or played to the user. In a business communication, for example, some of the content may be common to each communication of a particular type of communication (e.g., an invoice) while other portions of the content may be specific to an intended recipient or user. The user specific content could include, for example, a name, address, account number, a listing of charges and/or any additional information specific to the user. The common or non-user specific content could include, for example, a header, color scheme, trademarks, logos, and/or the overall look or layout of the communication.

Upon receiving such a communication, the browser interprets the control tags and formats the data according to the structure specified by the control tags to create a viewable object that the browser displays, plays or otherwise performs to the user. A control tag may direct the browser to retrieve a page from another source and place it at the location specified by the control tag. In this way, the browser can build a viewable object that contains multiple components such as text, images, hotlinks, sound, spreadsheets, and/or video objects, that is then displayed within a graphical user interface. Browsers can also refer to Cascading Style Sheets (CSS) to define the appearance and layout of text and other content.

HTML is the most common markup language for creating communications to be displayed in browsers. As generally indicated above, HTML is written in the form of HTML elements consisting of tags which most commonly come in pairs like <h1> and </h1>, although some tags represent empty elements and so are unpaired, for example <img>. The first tag in a pair is the start tag, and the second tag is the end tag. In between these tags, communication designers can add text, further tags, comments and other types of text-based content. HTML provides a means for creating communications by denoting structural semantics for text such as headings, paragraphs, lists, links, quotes and other items. HTML can also embed or insert scripts within the markup language which affect the behavior of HTML communications.

The HTML 5 markup language includes a canvas element that allows for dynamic, scriptable rendering of two dimensional shapes and bitmap images. The canvas element, or canvas, is a low level element that consists of a drawable region defined in HTML with height and width attributes. Applications using canvas use script (e.g., JavaScript®) to control the generation and interaction with the graphics or text placed in the canvas. Currently, canvas is supported by at least the current versions of Google® Chrome™, Safari®, Mozilla®, Firefox®, Internet Explorer™, Konqueror™, and Opera®. Older versions of Internet Explorer™, version 8 and earlier do not support canvas, however, Google® and Mozilla® plugins are available.

Additional browsers including those known now, or developed in the future, will likewise support HTML 5 and other markup languages which provide an element that allows for dynamic, scriptable rendering of two dimensional shapes and bitmap images such as the canvas element. The current invention, therefore, is not limited to the HTML 5 markup language or to existing browsers which support canvas but can be implemented in any communication written in a markup language, and in some embodiments, a markup language that supports an element that allows for dynamic, scriptable rendering of two dimensional shapes and bitmap images.

In the present invention, a web-based application template 11 (“application”) is created by defining the application in a markup language supported by a browser as a plurality of elements. The plurality of elements, in the present embodiment, may include ubiquitous HTML 5 components with a fixed purpose, for example, a check box, radio buttons, a text field, etc., or images, and containers, and additional markup language elements, or geometric shapes, input fields, calendar controls, chart controls, tables, and custom controls. Each of these elements may be styled using CSS as is well known in the art. Once created, the application 11 is stored for later retrieval by a user.

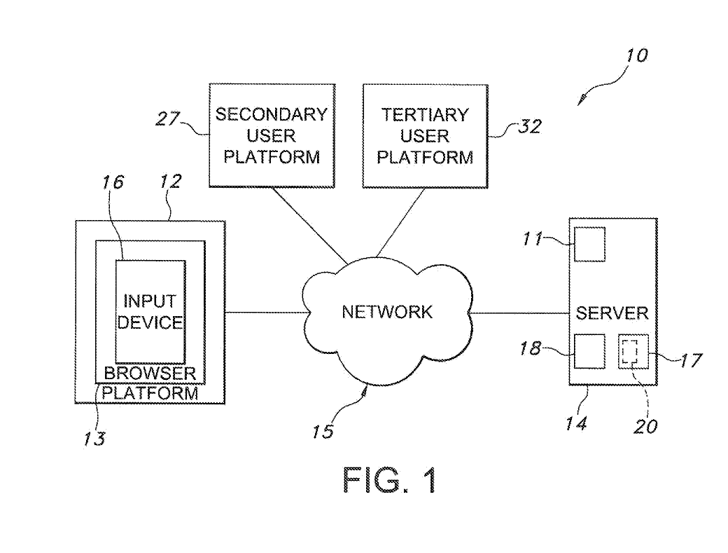

FIG. 1 is a block diagram of an exemplary communication system 10 through which an application 11 can be distributed to a primary user for use and/or customization in a first user session, and to a secondary, tertiary, or subsequent, users for use and/or further customization in second, third, or subsequent, user sessions. The system 10 may include a primary user device or platform 12 comprising a browser 13 that may be communicatively coupled to a server 14 over one or more networks 15. The platform 12 may include any computer, processor or other device on which a user may access a browser. The platform 12 may include, for example, a laptop computer, a smartphone, or mobile phone on which a user may view the application 11 using the browser 13. Examples of the embodiments for the platform 12, the server 14, and methods or any parts or function(s) thereof may be implemented using hardware, software modules, firmware, tangible computer readable or computer usable storage media having instructions stored thereon, or a combination thereof and may be implemented in one or more computer systems or other processing systems.

According to one embodiment, the browser 13 may include any device, application or module that enables a user or computer to navigate and/or retrieve data from another data source, typically over a network. The browser 13 may include, but is not limited to, any conventional web browser such as those that are widely available (e.g., Google® Chrome™, Safari®, Mozilla®, Firefox®, Internet Explorer™, Konqueror™, and Opera®). Older versions of Internet Explorer™, version 8 and earlier do not support canvas as required for some embodiments of the invention, however, Google® and Mozilla® plugins are available.

The browser 13 may include or otherwise be capable of rendering the text and images of an application defined in a markup language including a plurality of elements and having a scripting language inserted therein. In accordance with the broad teaching of the present invention, the browser 13 may be configured to use any number of protocols, known now or developed in the future, including protocols such as HTTP, FTP, and underlying protocols such as TCP/IP or UDP.

The browser 13 may further communicate with an input device 16, such as a touch screen or keyboard, to allow a user to initiate events such as input/edit data, input commands, or otherwise provide other control information to the browser. The browser 13 may request content from the server 14 based on the user input and the server may respond to a user request by providing content back to the browser and the platform 12 via the network 15. The browser 13 may also be configured to retrieve content from the server 14 without user prompting (e.g., the server may push and/or update data in the browser).

The network 15 may include any telecommunications or computer network that communicatively couples the platform 12 to the server 14. In one embodiment, the network 15 may include any type of data network or combination of data networks including, but not limited to, a local area network (LAN), a medium area network, or a wide area network such as the Internet. The network 15, for example, may be a wired or wireless network that allows the platform 12 and the server 14 to communicate with each other. The network 15 may further support world-wide-web protocols and services. The platform 12 may be a mobile phone or a tablet computer, for example, which is wirelessly connected to the Internet and the server through a service provider that maintains the network.

The server 14 may include a server that provides the application 11, or a portion thereof, to the platform 12 over the network 15. The application 11 may be provided from the server 14 over the network 15 that connects the platform 12 to the Internet for example. The application 11 may be a website having one or more webpages, including a webpage as hosted by, or otherwise provided by the server 14. The server 14 may include one or more web servers, data servers and/or other servers that include information used to generate the application 11. According to another embodiment, the server 14 may include a plurality of servers of a server farm or other network and/or service provider host(s). The server 14 may provide content such as web pages, communications, audio, video, etc., that may be retrieved or otherwise accessed by the platform 12 over the network 15. The content accessed by the platform 12 may be viewed, used, displayed or otherwise disseminated via the browser 13.

In another embodiment, the platform 12 and the server 14 may each be implemented on a computing device. Such a computing device may include, but is not limited to, a personal computer, mobile device such as a mobile phone or smartphone, a workstation, a tablet computer, an embedded system, a gaming console, a television, a set-top box, or any other computing device that can support a browser. Such a computing device may include, but is not limited to, a device having a processor and memory for executing and storing instructions. Such a computing device may include software, firmware, and/or hardware. The computing device may also have multiple processors and multiple shared or separate memory components. Software may include one or more applications and an operating system. Hardware can include, but is not limited to, a processor, memory and a graphical user interface display. An optional input device, such as a mouse, a keyboard, or a touch screen, may be used. According to another embodiment, the system functionality, as discussed above, may be performed at least in part on the platform 12 and/or the server 14, communicating over the network 15.

In order for a primary user to customize the application 11, the primary user retrieves the application from a database 17 on the server 14 and loads the application into a memory in a browser environment without desktop software, plug-ins or virtualized environment. The database 17 can be any type of database capable of organizing data. A database management system is used to interact with users, other applications, and the database itself to capture and analyze data and allows the definition, creation, querying, update, and administration of the database 17. Exemplary database management systems include MySQL, POSTgreSQL, SQLite, Microsoft SQL Server, Oracle, SAP, dBASE, FoxPro, IBM DB2, LibreOffice Base, FileMaker Pro, MongoDB, and other noSQL databases.

Web-based applications, such as the application 11, are viewable by users of computers, such as laptops, desktops or tablet computers, or through mobile devices, smartphones, or other like platforms utilizing a browser as described above. In accordance with the present invention, the application 11 may be customized in the browser 13 of the primary user's platform 12 without requiring the primary user to download or install additional code for capabilities that may not already be supported by the primary user's browser. This is the case regardless of the primary user's platform or operating system.

Customizing the application includes altering at least one of the plurality of elements. Alterations can occur through actions of the primary user, for example, through interaction of the primary user with the primary user's platform 12, or autonomously as directed by the elements of the application 11. Autonomous alterations can occur in response to the location of the primary user when the application is retrieved. For example, the geolocation data (e.g., longitude and latitude of the primary user's platform 12), may dictate that the application display monetary amounts in U.S. dollars vs. British pounds, or that a nearest bank branch location be determined and appropriate information concerning same (e.g., an address, map, or telephone number associated therewith) be provided to the primary user. Any number of variables within the application 11 may be dependent on such data, or other types of data which autonomously alter the application 11. In addition, the browser 13 may request content from the server 14 based on the user input and the server may respond to a user request by providing content back to the browser and the platform 12 via the network 15.

Similarly, the primary user can interact with the primary user's platform 12 through the input device 16, or otherwise, to add content or to modify content of elements included in the application 11. For example, the application 11 may include address fields or elements where the primary user can use the input device 16 to insert a street address, a city, a state, and a zip code. Additional information may likewise be added by the primary user by selecting check boxes using a computer mouse, voice control, or other input means. Alternatively, portions of the application 11 may be altered by selecting differing languages, color schemes, or themes.

In one embodiment, at least one of the plurality of elements defining the application 11 is a canvas element. The canvas element, or canvas, is used to display the content of the application 11 in a text area. The content may include both user specific content and non-user specific content including, for example, text, images, and other content, and a cursor, visual indicators (e.g., a red line beneath and indicating spelling errors), highlighting, underlining, and like items to be displayed in the text area which mimic a word processing environment. Anything used in an application 11 may be included as content in accordance with the present invention.

To accomplish the drawing or display of the content, script is inserted within the markup language to control the generation of and interaction with the content placed in the canvas or text area. In other words, the script forms an invisible client that controls the content, intercepts all user interactions with the content in the browser 13 (e.g., hover, move, click, keystrokes, paste, etc.), and alters or adds to the content as displayed in the text area accordingly. In the present embodiment, JavaScript® script is used for this purpose. The inserted script draws each user specific object and non-user specific object at coordinates established for the user specific object or non-user specific object in the text area as canvas natives visible in the browser 13. For a full description of the use of the canvas element to edit a communication, see Assignee's pending patent application Ser. No. 14/039,608 which is herein incorporated in its entirety by reference.

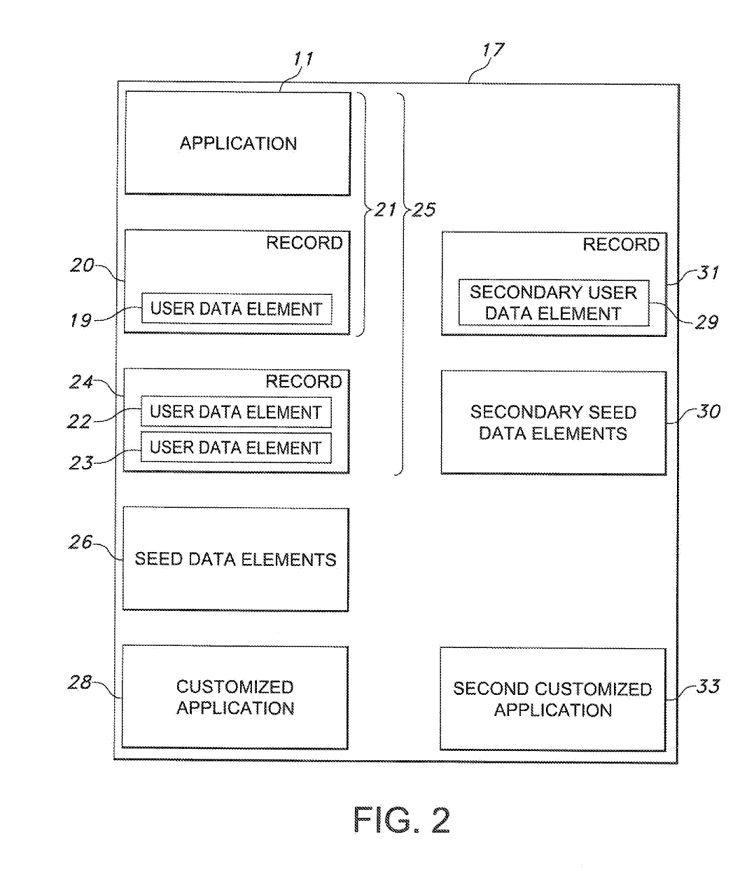

Each alteration to the application 11 is maintained in a change log as a data object or user data element 19. In other words, the user data element 19 includes a stack of changes made by the primary user in the first user session. The stack of changes, for example, could include “delete W,” “delete O,” “delete R,” and “delete D” representing deletion of the term “WORD” from a text area in the application 11. No matter what alteration(s) to the application is made by the first user, the user data element 19 representing the change is associated with the primary user and stored for later retrieval apart from the application 11 as shown in FIG. 2. In this embodiment, the user data element 19 is stored as a record 20 or object in the database 17 on the server 14 where the application 11 is stored. The record 20, however, could also be stored locally on the primary user's platform 12, or remotely apart from the platform 12 or server 14. In this manner, a secondary user can access the application 11 and the record 20 associated with the primary user in a browser 13 of a secondary user's platform 27 such that the application 11 and user data element 19 together represent a customized web-based application 21.

Once stored, the primary user can end the first, or current, user session. If the primary user desires to further customize the application 11 by making additional or secondary alterations, the primary user can retrieve the application 11 and the record 20 including the user data element 19 from the server 14. As in the first user session, alterations can occur through actions of the primary user or autonomously as directed by the elements of the application 11 or the record 20. The primary user can interact with the primary user's platform to add content or to delete or modify content included in the application 11 and/or the record 20.

Each secondary alteration to the application 11 and/or the record 20 is maintained in a secondary change log as additional user data elements 22, 23 or data objects. The additional user data elements 22, 23 which are indicative of the secondary alterations are stored as a second record 24 apart from the application 11 and the first record 20, but are still associated with the primary user. The second record 24 can be stored locally on the primary user's platform, remotely or, in this instance on the server 14 where the application 11 and first record 20 are stored. In this manner, a secondary user can access the application 11, the first record 20, and the second record 24 associated with the primary user in a browser 13 of the secondary user's platform 27 such that the application 11 and data elements 19, 22, and 23 together represent a customized web-based application 25.

These steps of retrieving the application, altering at least one of the plurality of elements, storing user data elements indicative of subsequent alterations, and associating the stored subsequent user data elements with the primary user can be repeated any number of times depending on the number of user sessions required for the primary user to complete the task of customizing the application 11.

In this embodiment, the user data elements 19, 22, and 23 are published, or made available to secondary, tertiary, or subsequent users, once the primary user has completed the task of customizing the application 11. The user data elements 19, 22, and 23 are published as seed data element 26 associated with the primary user. In this instance, the seed data element 26 represents a merged composite of the user data elements 19, 22, and 23 representing each of the alterations made by the first user in the first and second user sessions. Alternately, each user data element 19, 22, and 23 could be published as three corresponding seed data elements in accordance with the invention, and could be published individually at the end of each first user session when multiple edits are performed in different sessions. In other words, publishing occurs whether the customization of the application 11 included altering a single element in a single session in which case a single seed data element is published, or one or more elements in one or more sessions in which case a plurality of seed data elements, or a merged seed data element, are published. Once published, the original application 11 and the seed data element 26 associated with the primary user are accessible by one or more secondary, or subsequent users, and together represent a customized application 28. The original application 11 and the seed data element 26 associated with the primary user may be merged and stored in the database 17 as a single customized application 28 or remain as independent records in the database which together represent the customized application.

For example, an employee of an insurance company may retrieve the original application template 11 and alter the application for use by a group of customers from a particular geographic region or employees in a department of the company. Once published, the original application 11, as altered by the employee, would be available for use as a customized application 28 by the group of customers or employees. In order to use the customized application 28, these secondary users would retrieve the original application 11 and the seed data 26 associated with the primary user/employee. In this manner, the original application 11 maintains its initial integrity for use by a different user/employee in creating a second customized application for use by a second group of customers, for example, from a differing geographic region. Even more, any corporate or umbrella alterations required to be made to the original application 11 can be made thereto with the alterations flowing automatically to the customized application 28 without having to alter the customized application(s).

As indicated in the above example, the secondary user may include a plurality of users. Each secondary user can retrieve the customized application 28 including the original application 11 and the seed data element 26 associated with the primary user, and alter the customized application. Alterations can occur through actions of the secondary users, for example, through interaction of the secondary users with the secondary users' platforms 27, or autonomously as described above for the primary user. Each of the remaining steps outlined for the primary user's alteration of the original application 11 are essentially the same for the alteration of the customized application 28 by the secondary users.

For instance, each of the secondary users are able to alter at least one of the plurality of elements of the application 11 and/or the seed data elements 26 associated with the primary user, store secondary user data elements 29 indicative of the alterations, and associate the secondary user data elements with the secondary user. Again, the secondary user data elements 29 may be published as secondary seed data elements 30 associated with the secondary user. In this manner, a tertiary or subsequent user can access the customized application 28 and the secondary seed data elements 30 associated with the secondary user in a browser 13 of the tertiary user's platform 32 such that the customized application 28 and secondary seed data elements 30 together represent a second customized web-based application 33.

These steps of retrieving the application and seed data, altering at least one of the plurality of elements and seed data, storing user data elements indicative of the subsequent alterations, associating the stored user data elements with the subsequent user, and publishing the same as subsequent seed data, can be repeated any number of times depending on the number of users and the number of users and customized applications desired.

In order to provide control over the customization of the application 11 by first, second, tertiary and subsequent users, rights may be associated with some or all aspects of the process. In one embodiment, the original application 11 is associated with retrieval rights which dictate whether users can retrieve the application from the database 17. This is accomplished through an authentication step when retrieval of the application 11 is attempted by the user. Additionally, retrieval rights for users may be associated with each of the plurality of elements included in the application 11 and retrieval of each element may require authentication. Similarly, alteration rights for users may be associated with the original application 11 and/or each of the plurality of elements of the application 11 and alteration may require authentication. Even more, the right to store user data elements indicative of the alteration(s) to the plurality of elements and/or the right to publish user data elements as seed data elements associated with the primary user may require authentication. Each of these rights may be associated with users based on their individual status (e.g., employee or customer/client), group status (e.g., claim adjusters, corporate officers, individuals insured under a certain policy), or based on any other status or factor.

Similar control may be desired over the use and alteration of the customized application 28 as well. In order to provide control over the customization of a customized application 28 by a second or subsequent user, rights may be associated with some or all aspects of the process. In one embodiment, the original application 11 and/or seed data elements 26 are associated with retrieval rights which dictate whether the second or subsequent user can retrieve the application and/or seed data elements from the database 17. This is accomplished through an authentication step when retrieval of the application 11 and/or seed data elements 26 is attempted. Additionally, retrieval rights for users may be associated with each of the plurality of elements included in the application 11 and/or seed data elements 26, and retrieval of each element from the database 17 may require authentication. Similarly, alteration rights for users may be associated with the original application 11, and/or each of the plurality of elements of the application 11, and/or seed data elements 26, and alteration may require authentication. Even more, the right to store secondary user data elements 29 indicative of the alteration(s) to the plurality of elements and/or seed data elements 26, and/or the right to publish secondary user data elements 29 as secondary seed data elements 30 associated with the secondary user may require authentication.

As is readily understood, each step of the customization process whether performed by a primary, secondary, tertiary, or subsequent user can be controlled through utilization of rights. The use and extent of use of such rights will be dependent on the application 11 and in accordance with business rules of the user of the application. Some applications may require a certain high level of security with regard to the gathering and exchange of user information while other applications may require a lesser level of security. Any level of security, including the use of passwords, biometrics, and encryption methods, can be added to the described embodiment dependent upon the user's requirements.

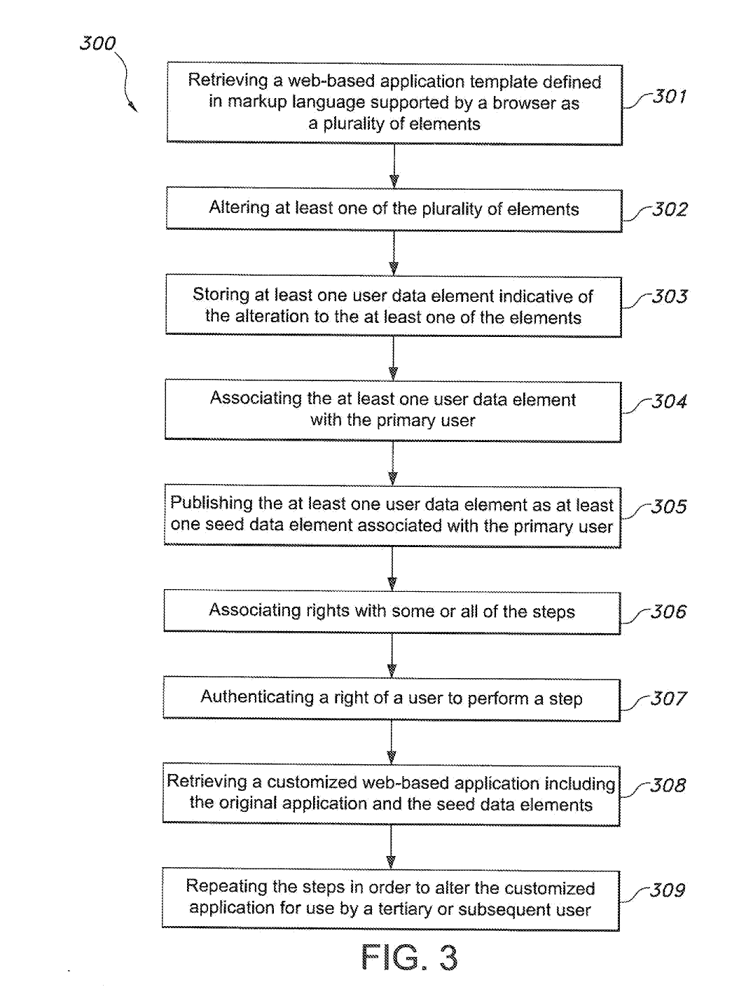

FIG. 3 is a flow diagram of a method 300 for customizing a web-based application in a browser by a primary user for use by a secondary user independent of the primary and secondary user's platform or operating system. The method 300 includes the step 301 of retrieving a web-based application template 11 defined in markup language supported by the browser as a plurality of elements. The plurality of elements may include ubiquitous HTML 5 components with a fixed purpose and additional markup language elements as are known in the art. Each of these elements may be styled using CSS as is also know in the art.

At step 302, at least one of the plurality of elements is altered. Alterations can occur through actions of the primary user, for example, through interaction of the primary user with the primary user's platform 12, or autonomously as directed by the elements of the application 11. Autonomous alterations can occur, for example, in response to the location of the primary user when the application 11 is retrieved. Each alteration to the application 11 is maintained in a change log as a data object or user data element 19. No matter what alteration(s) to the application 11 is made by the first user, the user data element 19 representing the change is associated with the primary user and stored in steps 303 and 304 for later retrieval. In this embodiment as described in detail above, the user data element 19 is stored as a record 20 in a database 17 on a server 14 where the application 11 is stored. In this manner, a secondary user can access the application 11 and the record 20 associated with the primary user in a browser 13 of a secondary user's platform 27 such that the application 11 and user data element 19 together represent a customized web-based application 21.

Once stored, the primary user can end the first, or current, user session. If the primary user desires to further customize the application 11 by making additional or secondary alterations, the primary user can repeat the steps of retrieving the application 11 and any user data elements from the server 14, altering at least one of the plurality of elements and any user data elements, storing user data elements indicative of subsequent alterations, and associating the stored subsequent user data elements with the primary user any number of times depending on the number of user sessions required for the primary user to complete the task of customizing the application 11.

At step 305, the user data elements are published, or made available to secondary, tertiary, or subsequent users, once the primary user has completed the task of customizing the application 11. The user data elements are published as a seed data element associated with the primary user. Once the publishing step is completed, the original application 11 and the seed data element associated with the primary user are accessible by one or more secondary, or subsequent users, and together represent a customized application 28.

In order to provide control over the customization of the application 11 by first, second, tertiary and subsequent users, rights may be associated as in step 306 with some or all aspects of the process. In one embodiment, the original application 11 is associated with retrieval rights which dictate whether users can retrieve the application from the database 17. This is accomplished through an authentication step 307 when retrieval of the application 11 is attempted by the user. Additional rights concerning the steps of retrieving, altering, storing, associating, and publishing for users may be associated with the original application 11 and/or each of the plurality of elements of the application 11 and may require authentication. Similar control may be desired over the use and alteration of the customized application 28 as well.

In a step 308 of the method, a secondary user can retrieve the customized application 28 including the original application 11 and the seed data element 26 associated with the primary user, and in step 309 alter the customized application. As with the primary user, alterations can occur through actions of the secondary user, for example, through interaction of the secondary user with the secondary user's platform 27, or autonomously as described above for the primary user. Each of the remaining steps outlined for the primary user's alteration of the original application 11 are essentially the same for the alteration of the customized application 28 by the secondary users.

For instance, each of the secondary users are able to alter at least one of the plurality of elements of the application 11 and/or the seed data elements 26 associated with the primary user, store secondary user data elements 29 indicative of the alterations, and associate the secondary user data elements with the secondary user. Again, the secondary user data elements 29 may be published as secondary seed data elements 30 associated with the secondary user. In this manner, a tertiary or subsequent user can access the customized application 28 and the secondary seed data elements 30 associated with the secondary user in a browser 13 of the tertiary user's platform 32 such that the customized application 28 and secondary seed data elements 30 together represent a second customized web-based application 33.

These steps of retrieving the application and seed data, altering at least one of the plurality of elements and seed data, storing user data elements indicative of the subsequent alterations, associating the stored user data elements with the subsequent user, and publishing the same as subsequent seed data, can be repeated any number of times depending on the number of users and the number of users and customized applications desired.

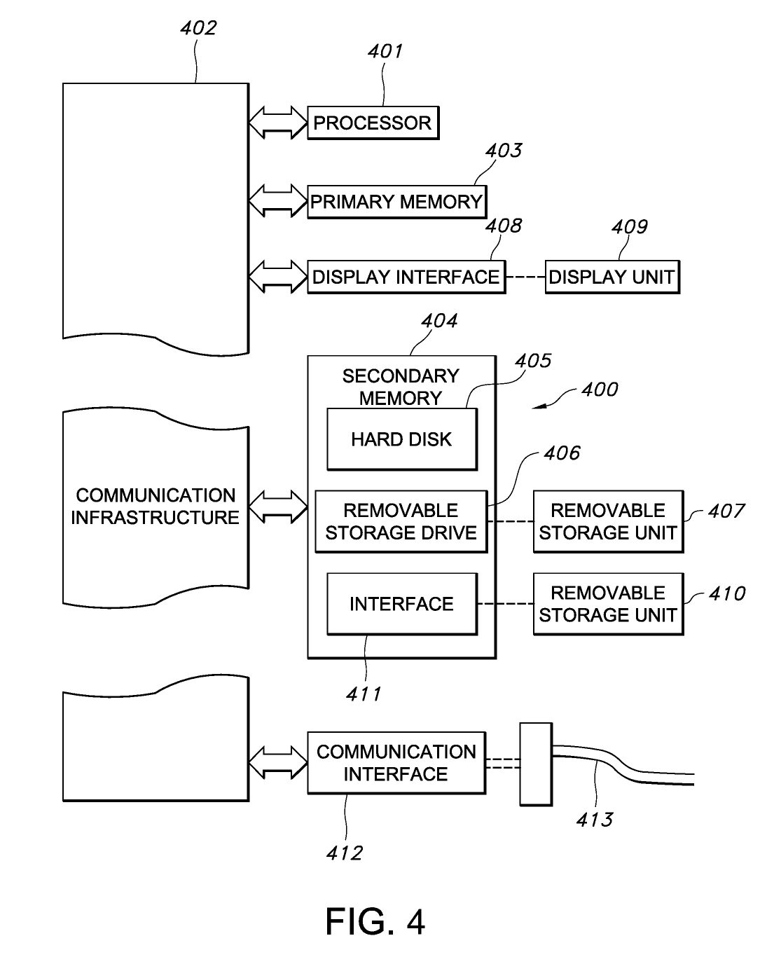

FIG. 4 is an example system 400 diagram of the invention that can be used to embody or implement embodiments, or portions thereof, as described herein. For example, the platforms 12, 27, 32 and/or server 14 may be implemented in a computer system 400, or another system similar thereto, using hardware, software, firmware, tangible computer readable media having instructions stored thereon, or a combination thereof and may be implemented in one or more computer systems or other processing systems. Hardware, software, or any combination of such may embody any of the modules, procedures, and components in FIGS. 1-4.

If programmable logic is used, such logic may execute on a commercially available processing platform or a special purpose device. One of ordinary skill in the art would appreciate that embodiments of the disclosed subject matter can be practiced with various computer system configurations, including for example, multi-core multiprocessor systems, minicomputers, mainframe computers, computers linked or clustered with distributed functions, as well as pervasive or miniature computers that may be embedded into virtually any device.

A computing device having at least one processor device and a memory, for example, may be used to implement the above-described embodiments. A processor device may be a single processor, a plurality of processors, or combinations thereof. Processor devices may have one or more processor cores as well.

Various embodiments of the invention are described in terms of this example computer system. After reading this description, it will become apparent to a person skilled in the relevant art how to implement the invention using other computer systems and/or computing architectures. Although operations may be described as a sequential process, some of the operations may in fact be performed in parallel, concurrently, and/or in a distributed environment, and with program code stored locally or remotely for access by single or multi-processor machines. In addition, in some embodiments, the order of operations may be rearranged without departing from the spirit of the disclosed subject matter.

A processor device 401 may be a special purpose or a general-purpose processor device. As will be appreciated by persons skilled in the relevant art, the processor device 401 may also be a single processor in a multi-core/multiprocessor system, such system operating alone, or in a cluster of computing devices operating in a cluster or server farm. Processor device 401 is connected to a communication infrastructure 402, such as, a network, bus, message queue, or multi-core message-passing scheme.

Computer system 400 also includes a primary memory, for example, random access memory (RAM), and may also include a secondary memory 404. Secondary memory 404 may include, for example, a hard disk drive 405, a removable storage drive 406, or other like memory devices. Removable storage drive 406 may comprise a floppy disk drive, a magnetic tape drive, a flash memory, an optical disk drive, or the like. The removable storage drive 406 reads from and/or writes to a removable storage unit as is known in the art. Removable storage unit 407 may likewise comprise a floppy disk, magnetic tape, flash memory, or the like which is read by and written to by removable storage drive 406. As will be appreciated by persons skilled in the relevant art, removable storage unit 405 includes a computer usable storage medium having stored therein computer software and/or data.

Computer system 400 may also include a display interface 408 that forwards graphics, text, and other data from communication infrastructure 402 for display on display unit 409. The display interface 408 may include input and output devices such as keyboards and mice, or the like (not shown).

In alternative implementations, secondary memory 4 4 may include other similar memory devices for allowing computer programs or other instructions to be loaded into the computer system 400. Such devices may include, for example, a removable storage unit 410 and an interface 411, a program cartridge and cartridge interface, removable memory chips, such as EPROMs or PROMs, and associated socket, and/or other removable storage units and interfaces which allow software and data to be transferred from the removable storage unit 407 to the computer system 400.

The computer system 400 may also include a communications interface 412. Communications interface 412 allows software and data to be transferred between computer system 400 and external devices, and may include a modem, a network interface (e.g., an Ethernet card), a communications port, a PCMCIA slot and card, or other like interfaces. Software and data transferred via communications interface 412 may be in the form of signals S, which may be electronic, electromagnetic, optical, or other signals capable of being received by communications interface. These signals S may be provided to a communications interface 412 via a communications path 413. Communications path 413 carries signals S and may be implemented using wire or cable, phone lines, cellular phone links, fiber optics, an RF link, or other communication channels.

In this document, the terms “computer program medium” and “computer usable medium” are used to generally refer to media such as the removable storage units 407 and/or 410, and a hard disk installed in hard disk drive 405. Computer program medium and computer usable medium may also refer to memories, such as the primary memory 403 and the secondary memory 404.

Computer programs are stored in the primary memory 403 and/or secondary memory 404. Computer programs may also be received via a communications interface. Such computer programs, when executed, enable the computer system to implement the present invention as discussed herein. In particular, the computer programs, when executed, enable the processor device 401 to implement the processes of the invention, such as the stages in the method illustrated by the flowchart in FIG. 3. Accordingly, such computer programs represent controllers of the computer system 400. Where the invention is implemented using software, the software may be stored in a computer program product and loaded into computer system 400 using removable storage drive 406, interface 411, and hard disk drive 405, or communication interface 412.

Embodiments of the invention also may be directed to computer program products comprising software stored on any computer useable medium. Such software, when executed in one or more data processing device(s), causes a data processing device(s) to operate as described herein. Embodiments of the invention employ any computer useable or readable medium. Examples of computer useable mediums include, but are not limited to, primary storage devices (e.g., any type of random access memory) and secondary storage devices (e.g., hard drives, floppy disks, CD ROMS, disks, tapes, magnetic storage devices, and optical storage devices, MEMS, nanotechnological storage devices, and the like).

The breadth and scope of the present invention should not be limited by any of the above-described exemplary embodiments, but should be defined only in accordance with the following claims and their equivalents. Ultimately, skilled artisans should recognize at least the following advantages. Namely, they should appreciate that the foregoing supports the customization of a web-based application in a browser by a user independent of the user's platform or operating system. Naturally, any improvements along such lines should contemplate good engineering practices, such as simplicity, ease of implementation, unobtrusiveness, stability, etc.

The foregoing has been described in terms of specific embodiments, but one of ordinary skill in the art will recognize that additional embodiments are possible without departing from its teachings. This detailed description, therefore, and particularly the specific details of the exemplary embodiments disclosed, is given primarily for clarity of understanding, and no unnecessary limitations are to be implied. Modifications will become evident to those skilled in the art upon reading this disclosure and may be made without departing from the spirit or scope of the invention. Relatively apparent modifications, of course, include combining the various features of one or more figures with the features of one or more of the other figures.

1-159. (canceled)

160. In a computing system environment, a method of customizing a web-based application in a browser by a primary user for use by a secondary user independent of the primary and secondary user's platform or operating system, comprising:
retrieving a web-based application template defined in markup language supported by the browser, said template including a plurality of elements;
altering at least one of the plurality of elements;
storing at least one user data element indicative of the alteration to the at least one of the elements; and
associating the at least one user data element with the primary user.

161. The method of claim 160, wherein the step of altering at least one of the plurality of elements occurs through interaction by the primary user with the primary user's platform.

162. The method of claim 160, wherein said plurality of elements includes at least one canvas element, and
wherein the step of altering at least one of the elements includes altering or adding at least one element within said at least one canvas element through the interaction by the primary user with the primary user's platform.

163. The method of claim 160, further comprising the steps of retrieving (1) the web-based application template including the plurality of elements and (2) the at least one user data element associated with the primary user;
altering at least one of (1) the plurality of elements and (2) the at least one user data element associated with the primary user;
storing at least one additional user data element indicative of the secondary alteration to the at least one of (1) the plurality of elements and (2) the at least one user data element associated with the primary user; and
associating the at least one additional user data element with the primary user.

164. The method of claim 163, further comprising the step of publishing the at least one user data element and the at least one additional user data element as at least one seed data element associated with the primary user,
wherein the secondary user can access the web-based application template and the at least one seed data element associated with the primary user in a browser of the secondary user's platform such that the web-based application template and the at least one seed data element associated with the primary user together represent a customized web-based application.

165. The method of claim 163, wherein each of the plurality of elements of the web-based application template is associated with at least one right.

166. The method of claim 165, further comprising the step of authenticating a right of the primary user to retrieve each of the plurality of elements of the web-based application template.

167. The method of claim 166, further comprising the step of authenticating a right of the primary user to store the at least one primary user data element indicative of the alteration to the at least one of the plurality of elements.

168. The method of claim 167, further comprising the step of publishing the at least one user data element as at least one seed data element associated with the primary user,
wherein the secondary user can access the web-based application template and the at least one seed data element associated with the primary user in a browser of the secondary user's platform such that the web-based application template and the at least one seed data element associated with the primary user together represent a customized web-based application.

169. The method of claim 168, further comprising the step of establishing at least one right for the at least one seed data element associated with the primary user.

170. The method of claim 169, wherein the established at least one right for the at least one seed data element associated with the primary user determines whether the secondary user can (1) retrieve the at least one seed data element and (2) alter the at least one seed data element.

171. The method of claim 170, further comprising the step of authenticating a right of the secondary user to retrieve the at least one seed data element associated with the primary user.

172. The method of claim 171, wherein the secondary user includes a plurality of users and each of the plurality of secondary users is able to retrieve the web-based application template and the at least one seed data element associated with the primary user, and wherein each of the plurality of secondary users is able to alter at least one of (1) the plurality of elements and (2) the at least one seed data element associated with the primary user, store at least one secondary user data element indicative of the alteration, and associate the at least one secondary user data element with the each of the plurality of secondary users.

173. The method of claim 172, further comprising the step of publishing the at least one secondary user data element as at least one secondary seed data element associated with each of the plurality of secondary users,
wherein a tertiary user can access the web-based application template, the at least one seed data element associated with the primary user, and the at least one secondary seed data element associated with each of the plurality of secondary users in a browser of the tertiary user's platform such that the web-based application template, the at least one seed data element associated with the primary user, and the at least one secondary seed data element associated with each of the plurality of secondary users together represent a customized web-based application.

174. In a computing system environment, a method of customizing a web-based application in a browser by multiple levels of users independent of the user's platforms or operating systems, comprising:
retrieving (1) a web-based application template defined in markup language supported by the browser, said template including a plurality of elements, and (2) at least one prior seed data element indicative of an alteration to at least one of the plurality of elements made by a prior level user;
altering at least one of (1) the plurality of elements and (2) the at least one prior seed data element;
storing at least one current level user data element indicative of the alteration to the at least one of (1) the plurality of elements and (2) the at least one prior seed data element; and
associating the at least one current level user data element with a current level user.

175. The method of claim 174, wherein said plurality of elements includes at least one canvas element, and
wherein the step of altering at least one of (1) the plurality of elements and (2) the at least one prior seed data element includes altering at least one element within said at least one canvas element through interaction by the current level user with the current level user's platform.

176. The method of claim 175, further comprising the step of retrieving (1) the web-based application template including the plurality of elements, (2) the at least one prior seed data element associated with the prior level user, and (3) the at least one current level user data element;
altering at least one of (1) the plurality of elements, (2) the at least one prior seed data element associated with the prior level user, and (3) the at least one current level user data element;
storing at least one additional current level user data element indicative of the secondary alteration to the at least one of (1) the plurality of elements, (2) the at least one prior seed data element associated with the prior level user, and (3) the at least one current level user data element; and
associating the at least one additional current level user data element with the current level user.

177. A system comprising:
one or more computers; and
a computer-readable medium coupled to the one or more computers having instructions stored thereon which, when executed by the one or more computers, causes the one or more computers to perform operations for customizing a web-based application in a browser by a primary user for use by a secondary user independent of the primary and secondary user's platform or operating system comprising:
retrieving (1) a web-based application template defined in markup language supported by the browser, said template including a plurality of elements, and (2) at least one prior seed data element indicative of an alteration to at least one of the plurality of elements made by a prior level user;
altering at least one of (1) the plurality of elements and (2) the at least one prior seed data element;
storing at least one current level user data element indicative of the alteration to the at least one of (1) the plurality of elements and (2) the at least one prior seed data element; and
associating the at least one current level user data element with a current level user.

178. The system of claim 177, wherein the step of altering at least one of (1) the plurality of elements and (2) the at least one prior seed data element by the primary user occurs through interaction by the primary user with the primary user's platform.

179. The system of claim 178, wherein said plurality of elements includes at least one canvas element, and
wherein the step of altering at least one of (1) the plurality of elements and (2) the at least one prior seed data element includes altering at least one element within said at least one canvas element through interaction by the primary user with the primary user's platform.

180. The system of claim 179, wherein said computer-readable medium coupled to the one or more computers having instructions stored thereon which, when executed by the one or more computers, causes the one or more computers to perform operations for customizing a web-based application in a browser by a primary user for use by a secondary user independent of the primary and secondary user's platform or operating system further performs the step of publishing the at least one user data element and the at least one additional user data element as at least one seed data element associated with the primary user, wherein the second user can access the web-based application template and the at least one seed data element associated with the primary user in a browser of the secondary user's platform such that the web-based application template and the at least one seed data element associated with the primary user together represent a customized web-based application.
